(19) United States
(12) Patent Application Publication
(10) Pub. No.: US 2004/0186775 A1
(43) Pub. Date: Sep. 23, 2004

(54) Systems and methods for providing an improved toolbar

(76) Inventors: William A. Margiloff, New York, NY (US); Anthony M. Risicato, New York, NY (US); Keith M. Dallara, New York, NY (US)

Correspondence Address: BUCKLEY, MASCHOFF, TALWALKAR LLC, 5 ELM STREET, NEW CANAAN, CT, 06840, US

(21) Appl. No.: 10/766,964

(22) Filed: Jan. 29, 2004

Related U.S. Application Data
(60) Provisional application No. 60/443,511, filed on Jan. 29, 2003.
(60) Provisional application No. 60/443,513, filed on Jan. 29, 2003.
(60) Provisional application No. 60/443,512, filed on Jan. 29, 2003.

(51) Int. Cl. G06F 17/60

(52) U.S. Cl. 705/14

(57) ABSTRACT

According to some embodiments, methods and apparatus provide an improved toolbar. More specifically, in some embodiments the functionality of a toolbar may be manipulated in response to a single indication from a user. Also in some embodiments, a user may provide first and second indications prior to receiving advertising material. According to some embodiments, a user may receive a search result and provide a single indication causing the user to receive a comparison search.

### CROSS-REFERENCE TO RELATED APPLICATIONS

The present application claims priority under 35 U.S.C. § 119(e) to (i) U.S. Provisional Patent Application No. 60/443,511 entitled “Systems and Methods for Providing an Improved Toolbar,” (ii) U.S. Provisional Patent Application No. 60/443,513 entitled “Systems and Methods for Providing Locally Determined Contextual Advertising Information via a Communications Network,” and (iii) U.S. Provisional Patent Application No. 60/443,512 entitled “Systems and Methods For Selecting Graphical Advertisements To Be Provided To Users via a Communication Network,” all filed in the name of Margiloff et al. on Jan. 29, 2003. The present application is also related to (i) U.S. patent application Ser. No. __/___,___ entitled “Systems and Methods For Providing Contextual Advertising Information via a Communication Network” and (ii) U.S. patent application Ser. No. __/___,___ entitled “Systems and Methods for Selecting Graphical Advertisements To Be Provided To Users via a Communication Network,” filed concurrently herewith. The entire contents of these applications are incorporated herein by reference.

### FIELD

The present invention relates to graphical user interfaces. In particular, the present invention relates to systems and methods for providing an improved toolbar, such as a searchbar to be used in connection with a Web browser.

### BACKGROUND

It is known that a “toolbar” can be provided in a graphical user interface (GUI). For example, the INTERNET EXPLORER® web browser available from MICROSOFT® provides a toolbar generally including the following buttons: Back, Forward, Stop, Refresh, Home, Search, Favorites, History, and Print. A user may select one of the buttons to access web browser features (e.g., by clicking on the Favorites button to access web sites having addresses stored in the user's Favorites folder). Note that a toolbar might be built into the web browser application or be installed as an add-on, such as via a Browser Helper Object (BHO). Toolbars may also exist separately from application software and may appear, for example, in various positions on the GUI provided by a user's operating system.

A single interface could have a number of different toolbars. For example, one toolbar might be associated with one type of feature and another toolbar might be associated with another type of feature. Moreover, it is known that a user can select which toolbars will be provided (e.g., a user can de-select a toolbar that he or she does not want to use). This process, however, can be inconvenient for a user. For example, a user who wants to replace a first toolbar with a second toolbar might need to both (i) de-select the first toolbar and (ii) select the second toolbar. In some cases, multiple steps must be accomplished by the user to switch between two or more toolbars, activate and/or deactivate various toolbars, or change the functionality of a particular toolbar (e.g., customize the toolbar).

One type of toolbar, referred to herein as a “searchbar,” can help a user access information via a web browser. In some configurations, a searchbar may include a text box in which a user may type or enter one or more search terms. Typically for example, the user enters a query via the searchbar (e.g., “soda”) and receives a search result associated with that query (e.g., links to COKE® and PEPSI® web sites). For example, the GOOGLE™ searchbar provides results from a single search engine. It is also known that results from a number of different search engines may be combined and displayed to the user (e.g., meta-search engines such as C4™, METAFIND™, METACRAWLER™).

A user who accesses information via a web browser may be interested in receiving advertising information. For example, a user accessing a web site associated with a particular product or service might like to receive a coupon for that product or service. In this case, the user might also be interested in knowing if the advertising information was received from the web site or from a third party.

### BRIEF DESCRIPTION OF THE DRAWINGS

FIG. 1 is a block diagram overview of a system according to some embodiments.

FIG. 2 is a flow chart of a method according to some embodiments.

FIG. 3 illustrates a user display according to the embodiment of FIG. 2.

FIG. 4 is a flow chart of a method according to some embodiments.

FIG. 5 illustrates a user display according to the embodiment of FIG. 4.

FIG. 6 is a flow chart of a method according to some embodiments.

FIG. 7 illustrates a user display according to the embodiment of FIG. 6.

FIG. 8 is a block diagram of a user device according to some embodiments.

FIG. 9 is a portion of an advertisement database according to some embodiments.

### DETAILED DESCRIPTION

Some embodiments described herein are associated with a “toolbar.” As used herein, the term “toolbar” generally refers to a graphical user interface (GUI) having one or more buttons, icons, menus, and/or other user selectable features operable to send a command, trigger an event, initiate a software program, open an executable file, and/or otherwise execute a macro or other program code. Toolbars may reside within the GUI of a program or other software application, or may function and/or exist independent from any application or operating system. For example, web browser programs such as MICROSOFT® INTERNET EXPLORER® generally include a toolbar displayed horizontally across the upper portion of the web browser's GUI. Other toolbars such as the GOOGLE™ Toolbar or MICROSOFT® OFFICE™ Toolbar may “float” independently of any opened applications or may be “docked” in various locations in an operating system GUI (such as in the system tray of various MICROSOFT® WINDOWS™ operating systems).

Toolbars may generally have one or more “toolbar buttons” or “buttons”. As used herein, the terms “toolbar buttons” and “buttons” may be used interchangeably, and generally refer to any portion, area, and/or component of a GUI that is associated with the execution of one or more particular functions, procedures, programs, and/or commands. For example, the MICROSOFT® INTERNET EXPLORER® generally includes multiple areas within the GUI that may be selected by a user to execute certain commands. One such toolbar button is the “Home” button that includes an icon of a house within the selectable area. When selected by a user, the “Home” button causes the web browser to be directed to a pre-designated “Homepage”. In some embodiments, toolbar buttons may be or include selectable text such as menu items like the typical “File”, “Edit”, and “View” menu items available in most software applications.

In some embodiments a toolbar may include other features including, but not limited to, text boxes (such as searchbars or search boxes), forms, graphics, video, audio, and/or various menus such as drop down, pick-list, expandable, and/or dynamic menus.

System Overview

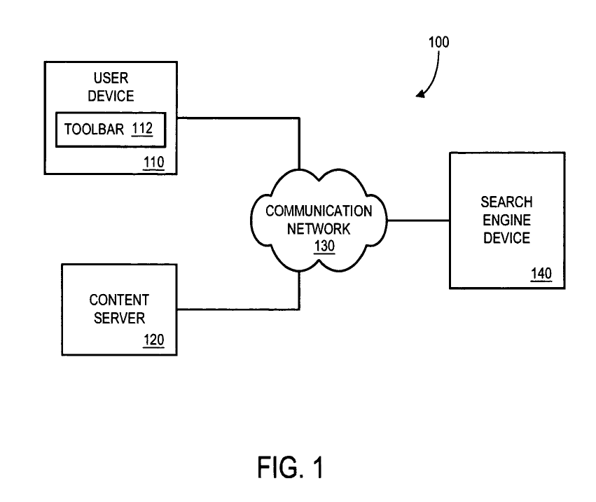

Turning now in detail to the drawings, in FIG. 1 a block diagram of a system 100 is depicted for use in explanation, but not limitation, of described embodiments. Upon reading this disclosure, those skilled in the art will appreciate that different types, layouts, quantities, and configurations of systems may be used.

In some embodiments, a user device 110 may include a toolbar 112 and may access information from a content server 120 via communication network 130. In some embodiments as described hereinafter, the toolbar 112 may be operable to change functionality based on a single indication from a user. The toolbar 112 may also, according to some embodiments, be used to facilitate the viewing and/or dissemination of advertisements and/or other information (e.g., search results, weather reports, stock quotes, etc.). The user device 110 may communicate via network 130 with a search engine device 140. For example, in some embodiments a user may utilize the toolbar 112 to enter a search term or other information associated with a search and/or query. The user device 110 may then transmit information associated with the query to the search engine device 140. The search engine device 140 may, at least in part in response to the user's query for example, transmit information associated with a search result to the user device 110 (e.g., a web page including links associated with appropriate content servers 120).

In some embodiments, the information from the search engine device may at least be partially displayed within, on, or adjacent to the toolbar 112. The user may then, for example, access one or more web pages provided by the content server 120 using the information provided by the search engine device 140. In some embodiments, a user may initiate multiple consecutive searches using the toolbar 112. Each consecutive search may be conducted, for example, using a different search engine device 140 and/or a different search method, criteria, and/or strategy.

According to some embodiments, the content server 120 may be or include an advertising server. For example, advertisements, coupons, and/or other promotional or informational material may be provided by the content server 120. In some embodiments, an advertisement and/or other information from the content server 120 may be displayed and/or otherwise accessible within or using the toolbar 112. For example, the toolbar 112 may be associated with and/or contain various rules regarding the display and/or use of advertisements or other material. In some embodiments, when a user operating the user device 110 accesses a particular website such as is identified by a specific Uniform Resource Locator (URL), the toolbar 112 may display and/or otherwise activate an advertisement. The advertisement may, for example, be located on and/or otherwise be associated with a content server 120. In some embodiments, a displayed advertisement and/or an advertisement selected for display may be chosen and/or selected contextually. In other words, an advertisement or other information may be displayed and/or activated by the toolbar 112 at least in part in response to a search and/or query initiated by a user operating the user device 110 and/or in response to a particular URL navigated to using the user device 110.

As used herein, devices (such as the user device 110, the content server 120, and the search engine device 140) may communicate via the communication network 130, such as a Local Area Network (LAN), a Metropolitan Area Network (MAN), a Wide Area Network (WAN), a proprietary network, a Public Switched Telephone Network (PSTN), a Wireless Application Protocol (WAP) network, a cable television network, or an Internet Protocol (IP) network such as the Internet, an intranet or an extranet. Note that the devices shown in FIG. 1 need not be in constant communication. For example, the user device 110 may only communicate with the content server 120 via the Internet on an as-needed basis. In some embodiments, for example, the user device 110 may be a Personal Computer (PC) that intermittently utilizes a dial-up connection to the Internet via an Internet Service Provider (ISP). In other embodiments the user device 110 may be in constant and/or high-speed communication with the content server 120 and/or with the search engine device 140 through the use of any known or available connection device such as a cable or Digital Subscriber Line (DSL) modem. According to some embodiments, the communication network 130 may be or include multiple networks of varying type, configuration, size, and/or functionality.

Although a single user device 110 and a single content server 120 are illustrated in FIG. 1, any number of these devices may be included in the system 100. Similarly, any number of the other devices described herein may be included in the system 100 according to some embodiments. A single content server 120 may, for example, be in communication with multiple user devices 110. In some embodiments, multiple content servers 120 may provide various information such as advertisements and/or web pages to one or more user device 110.

The user device 110 and the content server 120 may be any known or available devices capable of performing the various functions described herein. The user device 110 may be, for example: a PC, a portable computing device such as a Personal Digital Assistant (PDA), an interactive television device, or any other appropriate storage and/or communication device. Either or both of the content server 120 and the search engine device 140 may be, for example, advertising and/or content servers such as web servers.

One-Click Dynamic Changing of Toolbar Buttons

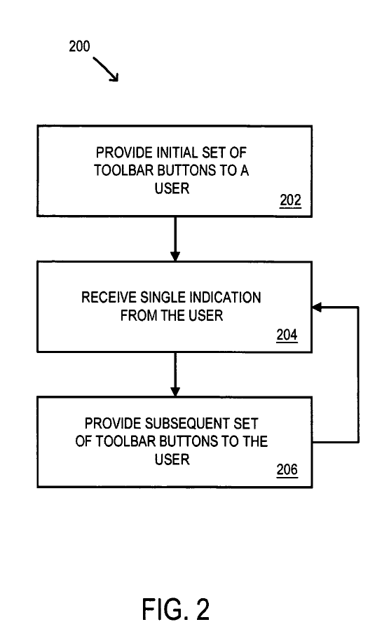

Referring now to FIG. 2, a flow chart of a method 200 according to some embodiments is shown. The method 200 may be associated with and/or performed by, for example, the system 100 (or one or more of the system components) described in conjunction with FIG. 1 above. The flow diagrams described herein do not necessarily imply a fixed order to the actions, and embodiments may be performed in any order that is practicable. Note that any of the methods described herein may be performed by hardware, software (including microcode), firmware, or any combination thereof. For example, a storage medium may store thereon instructions that when executed by a machine result in performance according to any of the embodiments described herein.

The method 200 may begin, for example, by providing an initial set of toolbar buttons to a user, at 202. In some embodiments, a plug-in application associated with a web browser might display the initial set of toolbar buttons to the user. According to some embodiments, the initial set of toolbar buttons may be or include buttons associated with a specific functionality. For example, the initial set of toolbar buttons may include buttons such as “News”, “Classifieds”, and “Weather”, all associated with “Local News” functionality. In some embodiments, the initial set of toolbar buttons may be customized by a user and/or may not be exclusively associated with a single and/or common functionality. Also in some embodiments, the toolbar containing the initial set of toolbar buttons may contain various other toolbar buttons not belonging to the initial set, including one or more other toolbar button sets.

According to some embodiments, a single indication may be received from the user, at 204. For example, an indication associated with a single mouse click or keystroke might be received from the user. For example, a user may click a particular toolbar button such as “Switch”, “Change”, “Cycle”, or “Next”. In some embodiments, the user may click an icon, symbol, and/or other graphically designated toolbar button. The user may also, for example, provide a single indication by “mousing-over” a toolbar button and/or other toolbar area. According to some embodiments, the user may provide a single indication by entering a keystroke and/or keystroke combination such as “CTRL+T” (i.e., a “Hot Key”). Also according to some embodiments, the indication may be provided via any other known or available technology such as voice response, Infrared Radiation (IR), Radio Frequency (RF), and/or any other communicative indication.

At 206, a subsequent set of toolbar buttons may be provided to the user. In some embodiments, the subsequent set of toolbar buttons may be provided at least in part in response to the single indication received from the user at 204. For example, the initial set of toolbar buttons may be “Local News” buttons as described above. The user may provide an indication by, for example, clicking a toolbar button identified as “Sports”. One or more toolbar buttons associated with “Sports”, such as “Scores”, “Teams”, and/or “Tickets”, may then be provided to the user via the toolbar. In some embodiments, the subsequent set of buttons (such as the “Sports” buttons) may replace the initial set of buttons (such as the “Financial” buttons). In other embodiments, the subsequent set may only partially replace the initial set or may be provided in addition to the initial set.

It should be noted that, according to some embodiments, the various toolbar button configurations and the addition and/or replacement of toolbar button sets all may occur within a single toolbar. In other words, although some (or even potentially all) of a toolbars buttons may be changed, replaced, and/or otherwise altered via a single mouse click (“one-click”), the toolbar itself may remain constant. In some embodiments, for example, the toolbar may retain any originally functionality such as searchbars, information display areas, and other buttons separate from those of either the initial or subsequent sets involved in method 200.

According to some embodiments, additional sets of toolbars buttons may be provided in response to additional indications received from the user (e.g., the system might cycle through five possible sets of toolbar buttons). Further, various other and/or additional toolbar features may be changed, manipulated, and/or configured based in part on a single indication received from a user. In some embodiments the indication may originate with another entity, object, and/or individual separate from the user. For example, the single indication may be provided by an event, trigger, and/or scheduling program that may be configured by a user, administrator, or other entity.

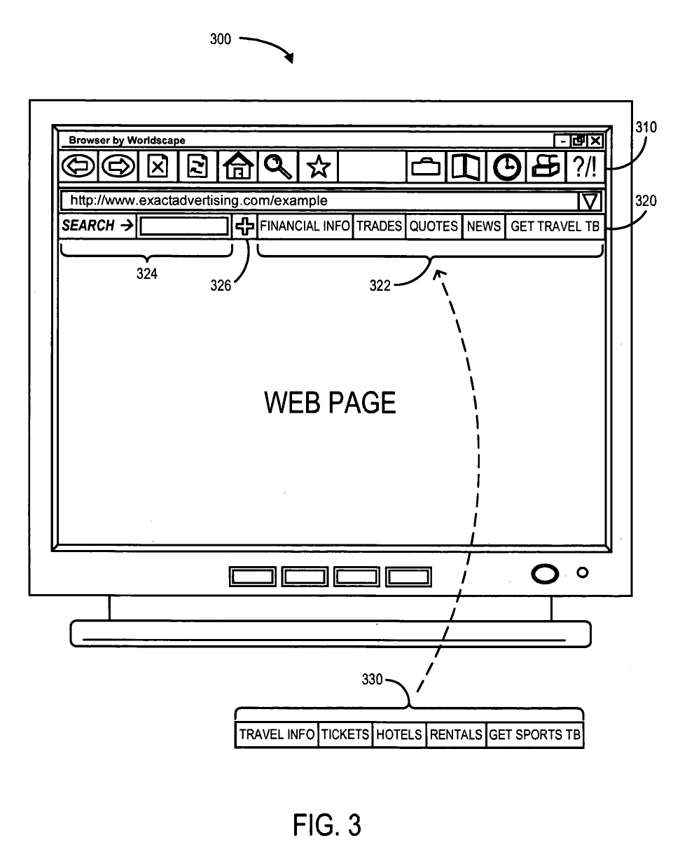

Turning now to FIG. 3, an example of a user display 300 according to some embodiments is shown. The user display 300 may, for example, be associated with the method 200 described above. In particular, the display 300 is associated with a web browser and includes a standard web browser toolbar 310 (e.g., a toolbar that lets the user navigate through web pages, save information, and print information). The display also includes a toolbar 320 according to some embodiments. In some embodiments, the toolbar 320 may be, or be similar in functionality to, the toolbar 112 described above. The user can select buttons on the toolbar 320 to receive (in this configuration) financial information, execute stock trades, receive business news, and/or receive stock quotes. As shown in FIG. 3, for example, the toolbar 320 may include an initial set of buttons 322, a searchbar 324, and/or one or more other toolbar buttons such as icon button 326. In some embodiments the toolbar 320 may include other toolbar features not shown in FIG. 3 such as other toolbar buttons (either related or un-related to finance functions), additional and/or different searchbars, an information display area, various graphics or icons, and/or one or more menus of various types and/or configurations.

According to some embodiments (such as shown in FIG. 3), the user may select a “Get Travel TB” (“TB” standing for “Toolbar”) button within the initial set 322 (in some embodiments the “Get Travel TB” button may be differently named and/or identified, and/or may not be part of the initial set 322). Selection of the “Get Travel TB” button may, for example, cause the initial set of buttons 322 to be automatically replaced with a subsequent set of buttons 330 (e.g., including buttons associated with tickets, hotels, and car rentals). In this way, the user can easily and efficiently replace one set of buttons with another set (e.g., he or she does not need to both de-select the initial toolbar buttons 322 and manually select the subsequent toolbar buttons 330). In some embodiments, the subsequent set of buttons 330 may be added to the toolbar 320 without replacing the initial set 322.

According to some embodiments, other areas, components, and/or functionalities of the toolbar 320 (such as searchbar 324 or icon button 326) may remain unchanged after selection of the “Get Travel TB” button. In other embodiments, such as where the toolbar 320 may include only an initial set of buttons 322, an indication from a user (such as a click on the “Get Travel TB” button) may cause the entire toolbar 320 to be replaced. According to some embodiments, other portions of the toolbar 320 may also be altered, modified, reconfigured, and/or replaced upon indication from a user. For example, a graphic display area of the toolbar (not shown) may initially include a picture of a stock chart or other financially-related information. When the user clicks on the “Get Travel TB” button, the graphic may be switched, for example, to a travel-related picture, icon, chart, and/or other travel-related information.

Double Opt-In Coupon Service

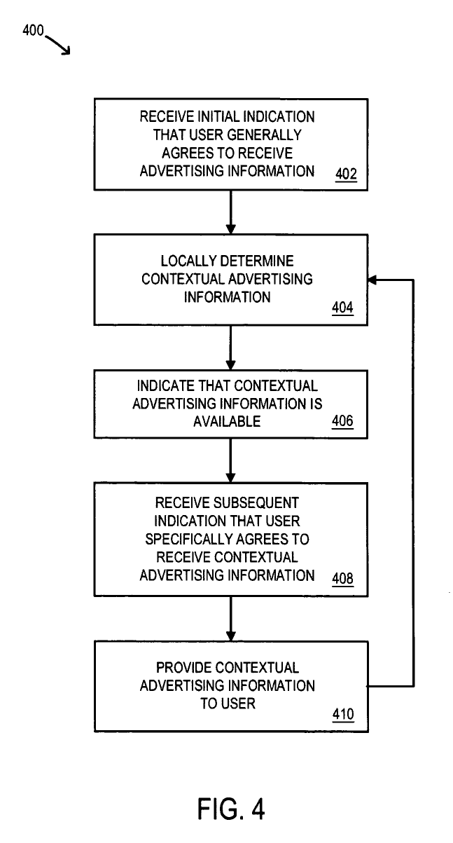

Turning now to FIG. 4, a flow chart of a method 400 according to some embodiments is shown. The method 400 shown in FIG. 4 may be performed, for example, by the user device 110 described in conjunction with FIG. 1 herein.

In some embodiments, an initial indication may be received from a user, at 402. In particular, the user may indicate that he or she generally agrees to receive advertising and/or other information. For example, the user might click on an “I Agree” button when installing a software program or may indicate agreement to accept such materials by, for example, signing up for a particular service, newsletter, or software download. Other indications may include, but are not limited to, verbal or other express indications and various implied indications. In some embodiments, a user may configure a toolbar (such as toolbars 112 or 320) in such a manner as to provide an indication. For example, a user may choose an option within the toolbar software that permits advertisements and/or other information to be displayed.

The method 400 may continue at 404, where contextual advertising information may be locally determined. For example, an application executing on the user device might monitor which web sites are being accessed by a web browser. The determination might be based on keywords, URL information, and/or meta-tags within Hypertext Markup Language (HTML) information. Some examples of contextual advertising are advertisements that are served due to matches of a search term and/or query, content on a web page, and a URL string. Consider a user who accesses an online travel web site. In this case, the contextual advertising information might be an advertisement for a travel product or service. In some embodiments, the URL of the travel site may be known to be associated with travel services, for example. Users visiting such sites may generally therefore be considered to be interested in travel-related information.

In some embodiments, information may be provided to the user to indicate that the contextual advertising information is available, at 406. For example, a button might be added to a toolbar to indicate that the contextual advertising information is available. In some embodiments the button, icon, graphical, audio and/or visual indication associated with available advertising information may be bold, italicized, and/or may flash, move, and/or otherwise be formatted to draw the attention of the user. For example, a user may visit a travel website using a browser and/or a toolbar. If an advertisement, coupon, or other promotional material is available that may be associated with either the travel site and/or travel-related products or services, a button on the user's toolbar may flash, become active, be given focus, and/or otherwise indicate to the consumer that contextual information is available (e.g., such as a coupon for a discount resort rate).

At 408, a subsequent indication may be received from the user. In particular, the user may indicate that he or she specifically agrees to receive the contextual advertising information. For example, the user might click on the button that was added to the toolbar (or an existing button associated with contextual information that became active, for example). In some embodiments, the user may provide any other indication that is known, available, and/or described herein. According to some embodiments, a user may provide an implied indication. For example, a pre-set time period (such as ten seconds) may elapse, after which the contextual information is automatically displayed. In some embodiments, the user may provide an indication by enabling and/or configuring such a time-lapse feature within the software of a toolbar, for example.

The method 400 may continue by providing the contextual advertising information to the user (e.g., a coupon might be displayed to the user), at 410. In some embodiments, the contextual information may be displayed to the user in the form of a list, table, and/or hyperlink. For example, where multiple advertisements or other forms of information such as coupons are available, a list of the available information may be provided to the user. In some embodiments, the user may then select one or more contextual information items from the list for viewing, printing, and/or for receiving further related information. Note that further contextual advertising may then be provided in response to further specific agreements and/or indications from the user (although only a single general agreement might be required from the user).

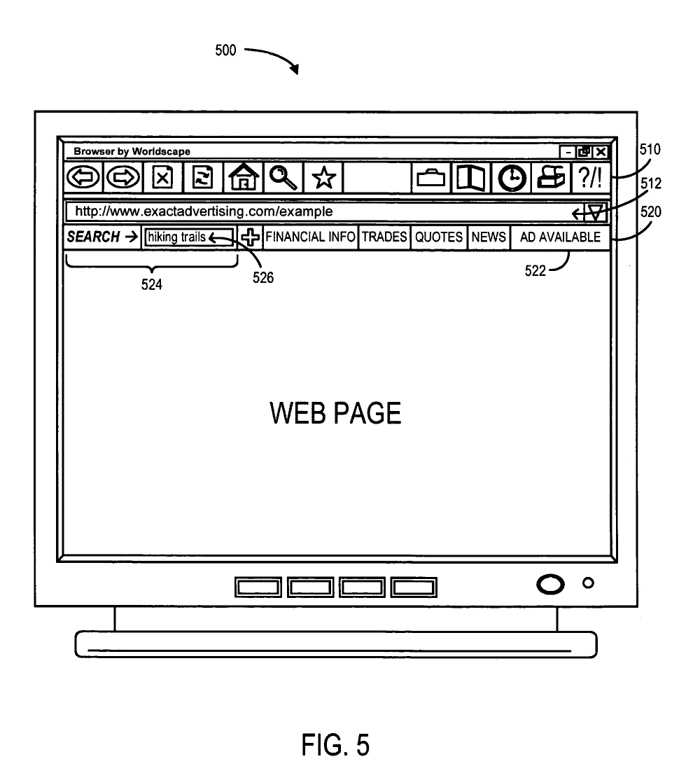

Referring now to FIG. 5, an example of a user display 500 according to some embodiments is shown. The user display 500 may, for example, be associated with the method 400 described above. In some embodiments, the display 500 may include a typical browser toolbar 510, an address bar 512, and a toolbar 520. The toolbar 520 may, according to some embodiments, be (or be similar to) either or both of the toolbars described above 112, 320. In some embodiments, the toolbar 520 may include an “Ad Available” button 522 and/or a searchbar 524. The “Ad Available” button 522 may, according to some embodiments, appears and/or otherwise become active when contextual advertising information is available. When the user selects the “Ad Available” button 522, the advertisement (or other contextual information) may be provided to the user (e.g., a small advertisement might appear in place of the button, might scroll down from the button, may appear elsewhere on the user's screen, and/or may be e-mailed to the user). In this way, the user may easily realize, for example, that the advertisement is not associated with the web page.

In some embodiments, the contextual information may be provided based in part on one or more actions, parameters, and/or other metrics associated with the user (and/or with the user device). For example, the user may visit a web site having a URL of “http://www.exactadvertising.com/example” (such as shown in the address window 512 of FIG. 5). The URL may have a known association with one or more types or categories of products and/or services. The URL may be associated with a company that sells shoes, for example. In some embodiments, the association with “shoes” may be used to select a contextual advertisement or other information such as, for example, a coupon for orthopedic shoe inserts.

According to some embodiments, the contextual information may be similarly selected and/or identified based upon a search term such as the search term “hiking trails” 526. In some embodiments, a combination of factors may be used to select and/or identify contextual information. For example, the combination of the URL associated with “shoes” and the use of the search term “hiking trails” 526 may indicate that the user has an interest in “hiking shoes”. Contextual information such as an article on selecting the best hiking shoes may therefore be selected, displayed, and/or made available to the user.

One-Click Comparison Search

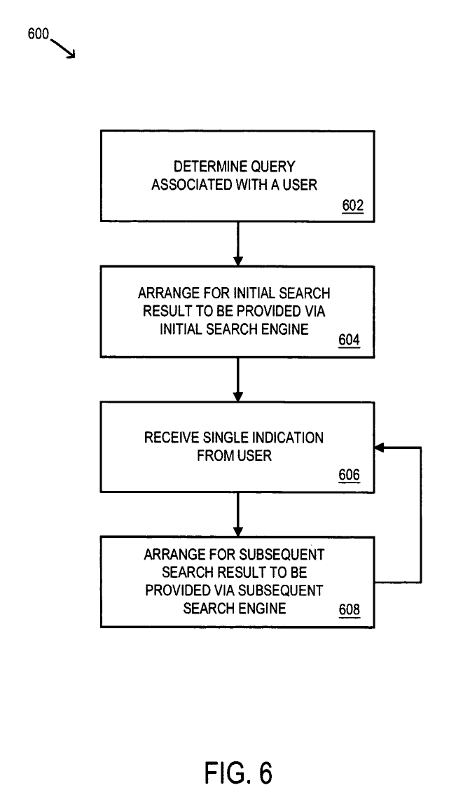

FIG. 6 is a flow chart of a method 600 according to some embodiments. The method 600 shown in FIG. 6 may be performed, for example, by the user device 110.

The method 600 may begin, for example, by determining a query associated with a user, at 402. For example, the user might type a word or phrase into a searchbar field (e.g., the user might type “telephone company phone rates”) and/or select one or more pre-defined search words and/or terms. In some embodiments, a user may define and/or store one or more predefined queries that the user selects to perform. For example, the user may configure a query to locate various long-distance telephone rates available in the user's local area. Because such rates may change on a regular basis, the user may save the query and may, for example, pick the saved query from a list of available saved queries every time the user wishes to update the search results. In some embodiments, the user may schedule the query to be executed at various times and/or time intervals. In some embodiments, the user's query may be submitted, for example, using a toolbar such as toolbars 112, 320, 520 described herein.

The method 600 may continue at 604, where it may be arranged for an initial search result associated with the query to be provided to the user via an initial search engine. For example, the user's web browser might display a GOOGLE™ web page that lists a number of links that are associated with the phrase “telephone company phone rates.” According to some embodiments, this may be performed by sending a message from the web browser to a search engine device (e.g., in the proper format). Using the system 100 as an example, a toolbar 112 may be used to enter a search and/or query. A user device 110 may then send information indicative of the query to a search engine device 140. In some embodiments the arranging may end with the transmittal of information to a search engine device (such as search engine device 140). In other embodiments, further actions may be taken and/or performed to arrange for an initial search result to be provided to the user. For example, various user and/or user device information may be provided to the search engine device to permit the results to be appropriately directed to the user.

At 606, a single indication may be received from the user. For example, an indication associated with a single mouse click or keystroke might be received from the user. In some embodiments, the single indication may be (or be similar to) the indications 204, 402, 408 described in conjunction with methods 200 and 400 above.

The method 600 may continue at 608, by arranging for a subsequent search result associated with the query to be provided to the user via a subsequent search engine. In some embodiments, the subsequent search result may be, at least in part, in response to the received indication. For example, a user may click on a “Search” or other button which may cause the user's web browser to automatically replace the GOOGLE™ search results web page with an ALTA VISTA™ search results web page. In some embodiments, the subsequent search results may be provided to the user in addition to the initial search results. The search results may also be compared to each other and/or displayed together. Additional search results may then be provided in response to additional indications received from the user (e.g., the system might cycle through results from five possible search engines).

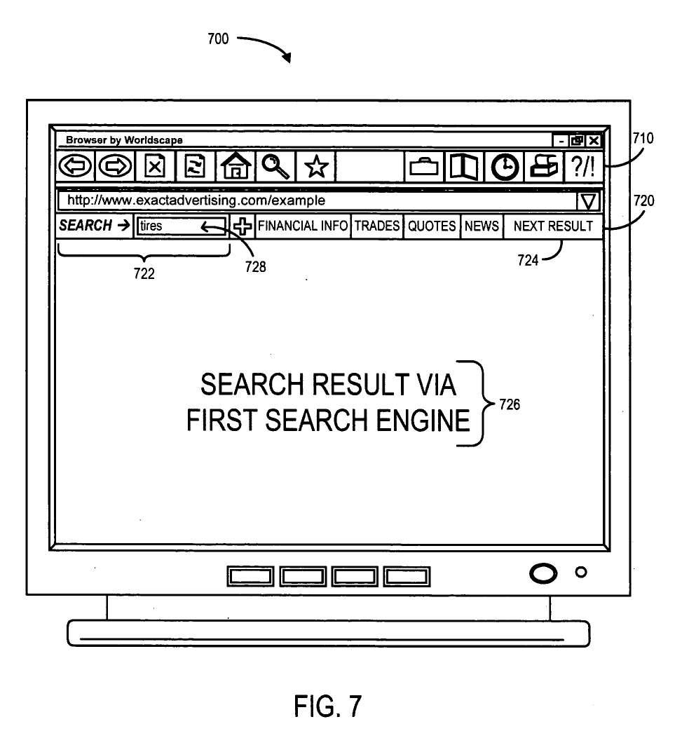

Turning now to FIG. 7, an example user display 700 according to some embodiments is shown. The display 700 may be associated, for example, with the method 600 described above. In some embodiments, the display 700 may include a typical browser toolbar 710 and a toolbar 720. The toolbar 720 may, according to some embodiments, be (or be similar to) any or all of the toolbars described above 112, 320, 520. In some embodiments, the toolbar 720 may include a searchbar 722 and a “Next Result” button 724. The “Next Result” button 724 may, for example, be selected by a user to switch between and/or cycle through search results 726 associated with various search engines. In some embodiments, a new web page (generated by another search engine) may be displayed in place of an initial search results web page 726 in response to the user's selection of the “Next Result” button 724.

For example, the user may enter a search term “tires” 728 in an attempt to locate information on the Internet regarding automobile tires. In some embodiments the user may enter a keystroke (such as hitting the “Return” button on the user's keyboard) and/or click a button or toolbar area such as the area where the word “Search” appears in toolbar 720 to execute an initial search. The initial search may be conducted, for example, using a first search engine and may return a web page of search results 726. The user may then, according to some embodiments, click the “Next Result” button 720 to initiate a subsequent search for “tires” 728 using a second or subsequent search engine, search strategy, and/or different search parameter. The subsequent search results may then be provided to the user in any known and/or available form or manner.

User Device

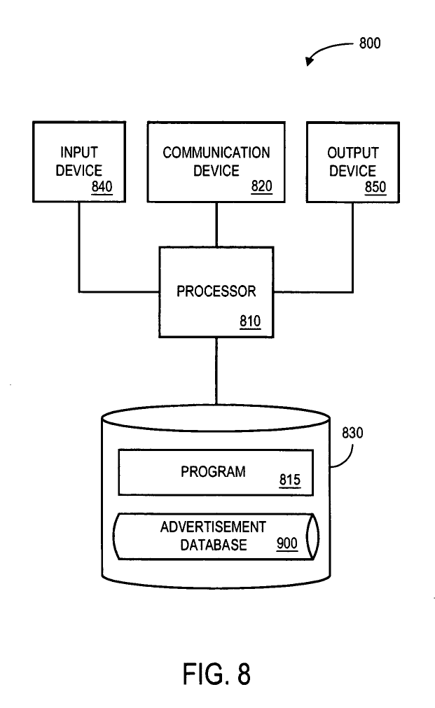

Turning now to FIG. 8, an exemplary user device 800 that may be, for example, descriptive of the user device 110 shown in FIG. 1, and that is in accordance with some embodiments is shown. The user device 800 may include a processor 810, such as one or more INTEL® Pentium® processors, coupled to a communication device 820 configured to communicate via a communication network (not shown in FIG. 8). The communication device 820 may be used to communicate, for example, with one or more content servers 120 and/or search engine devices 140 as described in conjunction with system 100 herein. The user device 800 may further include an input device 840 (e.g., a mouse and/or keyboard) and an output device 850 (e.g., a computer monitor).

In some embodiments, the processor 810 may also communicate with a storage device 830. The storage device 830 may comprise any appropriate information storage device known or available, including, but not limited to, combinations of magnetic storage devices (e.g., a hard disk drive), optical storage devices, and/or semiconductor memory devices such as Random Access Memory (RAM) devices and Read Only Memory (ROM) devices. The storage device 830 may, for example, store a program 815 for controlling the processor 810. The processor 810 may perform instructions of the program 815, and for example, thereby operate in accordance with embodiments described herein. For example, the processor 810 may arrange for a toolbar (such as toolbar 112, 320, 520, 720) to be displayed to a user.

The program 815 may be stored in a compressed, uncompiled and/or encrypted format. The program 815 may furthermore include other program elements, such as an operating system, a database management system, and/or device drivers used by the processor 810 to interface with peripheral devices.

As used herein, information may be “received” by or “transmitted” to, for example: (i) the user device 800 from another device; or (ii) a software application or module within the user device 800 from another software application, module, or any other source. Although the components 810-850 are described with respect to a user device 800 (such as user device 110), those skilled in the art will appreciate that the other devices described herein may include these and/or similar components or functionalities. The user device 800 (and other devices) may also include fewer or more components than those shown in FIG. 8.

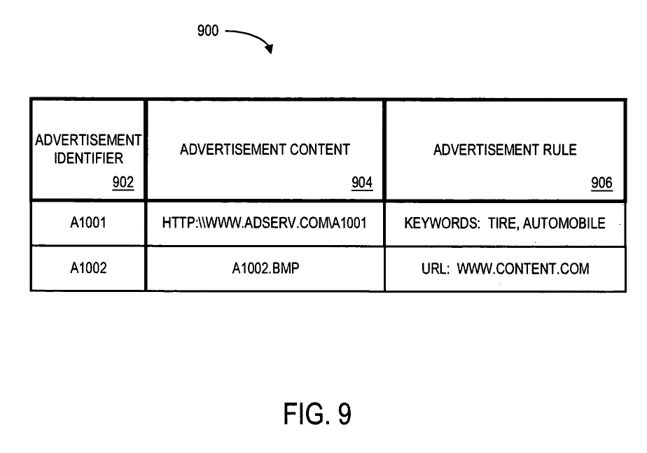

In some embodiments (such as shown in FIG. 8), the storage device 830 also may store an advertisement database 900. The database 900 may be used, for example, to store contextual advertisements and/or other promotional and/or contextual material or information. In some embodiments, the information stored in database 900 may be used, for example, to provide information in accordance with method 400 described herein. One example of a database 900 that may be used in connection with the user device 800 will now be described in detail with respect to FIG. 9.

Advertisement Database

Referring to FIG. 9, a table is shown that represents the advertisement database 900 that may be stored at the user device 800 according to some embodiments. The table may include, for example, entries identifying advertisements that might be provided via the output device 850. The table may also define fields 902, 904, 906 for each of the entries. The fields 902, 904, 906 may, according to some embodiments, specify: an advertisement identifier 902, advertisement content 904, and/or an advertisement rule 906. The information in the advertisement database 900 may be created and updated, for example, based on information received from an advertisement server (e.g., on a nightly basis).

The advertisement identifier 902 may be, for example, an alphanumeric code associated with an advertisement that might be displayed to a user. The advertisement content 904 might comprise, for example, a pointer indicating from where advertisement information (e.g., text, graphic, audio, and/or executable information) can be retrieved or may be or include the information itself. The advertisement rule 906 might indicate when the advertisement should be provided to the user (e.g., based on a keyword or URL).

Additional Embodiments

The following illustrates various additional embodiments. These additional embodiments do not constitute a definition of all possible embodiments, and those skilled in the art will understand that many other embodiments may be possible and/or practicable. Further, although the following embodiments are briefly described for clarity, those skilled in the art will understand how to make any changes, if necessary, to the above-described apparatus and methods to accommodate these and other embodiments and applications.

According to some embodiments, advertisements may be selected for the user based in part on bidding and/or ranking information. For example, advertisers might bid on relevant placements within a searchbar and/or a toolbar (such as the various toolbars described herein). That is, placement might be determined by a rate an advertiser is willing to pay.

According to some embodiments, targeted text ads may be embedded in the toolbar (or fed directly into a pre-populated “box”) based on a user's search query.

According to some embodiments, “popular searches” can be selected by the user (e.g., the twenty most popular queries). For example, the system might track specific keywords and keyword phrases users are searching for. Advertisers could then buy these “most searched for” keywords. The ability to track the popularity of each individual keyword and keyword phrase might help determine where user interest and advertiser message intersect.

The present invention has been described in terms of several embodiments solely for the purpose of illustration. Persons skilled in the art will recognize from this description that the invention is not limited to the embodiments described.

What is claimed is:

1. A method of facilitating use of a graphical user interface toolbar, comprising:
providing to a user an initial set of toolbar buttons in a toolbar;
receiving a single indication from the user; and
providing to the user a subsequent set of toolbar buttons in the toolbar at least in part in response to the received indication.

2. The method of claim 1, further comprising:
providing to the user additional sets of toolbar buttons in the toolbar at least in part in response to additional received indications.

3. The method of claim 1, wherein each toolbar button within the initial set of toolbar buttons is related to a common class of functionality.

4. The method of claim 1, wherein each toolbar button within the subsequent set of toolbar buttons is related to a common class of functionality.

5. The method of claim 1, wherein the subsequent set of toolbar buttons replaces the initial set of toolbar buttons within the toolbar.

6. The method of claim 5, wherein the toolbar includes at least one other toolbar feature in addition to the initial set of toolbar buttons, and the at least one other feature is not replaced by the subsequent set of toolbar buttons.

7. A method of presenting advertising information, comprising:
receiving from a user an initial indication that the user generally agrees to receive advertising information;
locally determining contextual advertising information;
providing information to the user to indicate that the contextual advertising information is available;
receiving from the user a subsequent indication that the user specifically agrees to receive the contextual advertising information; and
providing the contextual advertising information to the user at least in part in response to the initial and subsequent indications from the user.

8. The method of claim 7, further comprising:
arranging for additional contextual advertising information to be provided in response to additional indications from the user.

9. The method of claim 7, wherein the initial indication includes an acceptance by the user of an end-user license agreement.

10. The method of claim 7, wherein the contextual advertising information is determined local to a user device operated by the user.

11. A method for facilitating searching via a graphical user interface, comprising:
determining a query associated with a user;
arranging for an initial search result associated with the query to be provided to the user via a first search engine;
receiving a single indication from the user; and
arranging for a subsequent search result associated with the query to be provided to the user via a second search engine at least in part in response to the received indication.

12. The method of claim 11, further comprising:
arranging for additional search results associated with the query to be provided to the user via additional search engines at least in part in response to additional received indications.

13. An apparatus, comprising:
a processor; and
a storage device in communication with said processor and storing instructions adapted to be executed by the processor to:
provide to a user an initial set of toolbar buttons in a toolbar;
receive a single indication from the user; and
provide to the user a subsequent set of toolbar buttons in the toolbar at least in part in response to the received indication.

14. The apparatus of claim 13, wherein the instruction are further adapted to be executed by the processor to:
provide to the user additional sets of toolbar buttons in the toolbar at least in part in response to additional received indications.

15. The apparatus of claim 13, wherein each toolbar button within the initial set of toolbar buttons is related to a common class of functionality.

16. The apparatus of claim 13, wherein each toolbar button within the subsequent set of toolbar buttons is related to a common class of functionality.

17. The apparatus of claim 13, wherein the subsequent set of toolbar buttons replaces the initial set of toolbar buttons within the toolbar.

18. The apparatus of claim 17, wherein the toolbar includes at least one other toolbar feature in addition to the initial set of toolbar buttons, and the at least one other feature is not replaced by the subsequent set of toolbar buttons.

19. An apparatus, comprising:
a processor; and
a storage device in communication with said processor and storing instructions adapted to be executed by the processor to:
receive from a user an initial indication that the user generally agrees to receive advertising information;
locally determine contextual advertising information;
provide information to the user to indicate that the contextual advertising information is available;
receive from the user a subsequent indication that the user specifically agrees to receive the contextual advertising information; and
provide the contextual advertising information to the user at least in part in response to the initial and subsequent indications from the user.

20. An apparatus, comprising:
a processor; and
a storage device in communication with said processor and storing instructions adapted to be executed by the processor to:
determine a query associated with a user;
arrange for an initial search result associated with the query to be provided to the user via a first search engine;
receive a single indication from the user; and
arranging for a subsequent search result associated with the query to be provided to the user via a second search engine at least in part in response to the received indication.
